(19) United States
(12) Patent Application Publication
(10) Pub. No.: US 2014/0131978 A1
(43) Pub. Date: May 15, 2014

(54) SWIVEL PLATE ASSEMBLY FOR USE WITH A HITCH

(71) Applicant: Garry A. Sutton, Davis City, IA (US)

(72) Inventor: Garry A. Sutton, Davis City, IA (US)

(21) Appl. No.: 13/677,421

(22) Filed: Nov. 15, 2012

(51) Int. Cl. B60D 1/58

(52) U.S. Cl. CPC B60D 1/58
USPC 280/504

(57) ABSTRACT

A swivel plate assembly for use with a hitch has a swivel plate having a central opening and a pair of chain openings. The swivel plate is pivotally connected to the hitch and is also connected to the tongue by a pair of chains.

### BACKGROUND OF THE INVENTION

This invention is directed to a swivel assembly for use with a hitch and more particularly a swivel assembly that maintains a center point pull when hitch ball is sheared or the hitch malfunctions.

Hitch assemblies are well known in the art. Typically, a pair of chains are connected to the receiver attached to the vehicle and the tongue of the trailer. The purpose of the chains is to maintain a connection between the vehicle and the trailer in the event the trailer becomes disconnected. The chains, in order to maintain an acceptable turning radius, need to be a certain length. Unfortunately, in certain situations when the trailer becomes disconnected the length of the chain does not provide sufficient support and the tongue of the trailer engages the ground causing the trailer to flip. Thus, there is a need in the art for a device that addresses these problems.

An objective of the present invention is to provide a swivel member that maintains a central pull point during a malfunction.

Another objective of the present invention is to provide a locking stop to maintain a ball tongue connection during a malfunction.

These and other objectives will be apparent to one of ordinary skill in the art based upon the following written description, drawings, and claims.

### BRIEF SUMMARY OF THE INVENTION

A swivel plate assembly for use with a hitch having a swivel plate with a central opening and a pair of chain openings that is pivotally connected to a hitch assembly. The swivel plate assembly is also connected to a tongue of a trailer by a pair of chains.

### BRIEF DESCRIPTION OF THE DRAWINGS

FIG. 1 is a sectional end view of a swivel plate assembly; and

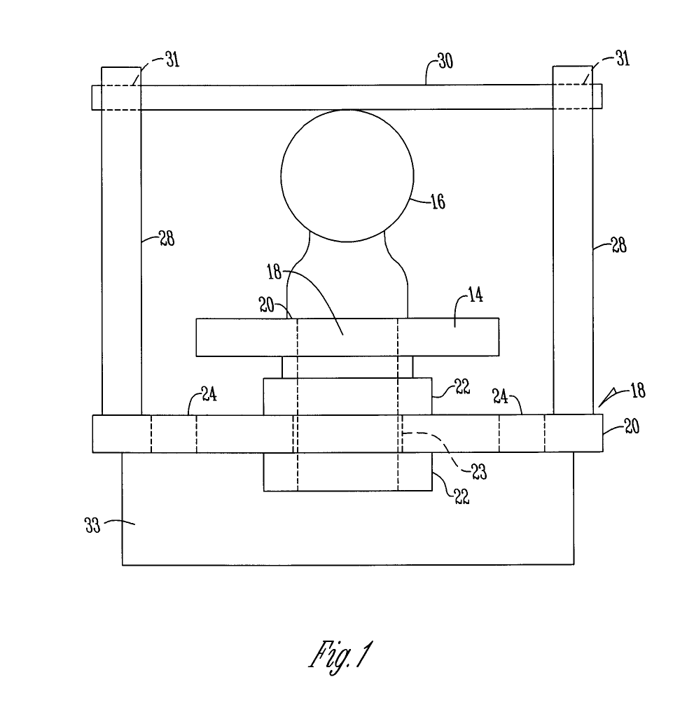

FIG. 2 is a side sectional view of a hitch assembly with a swivel plate assembly.

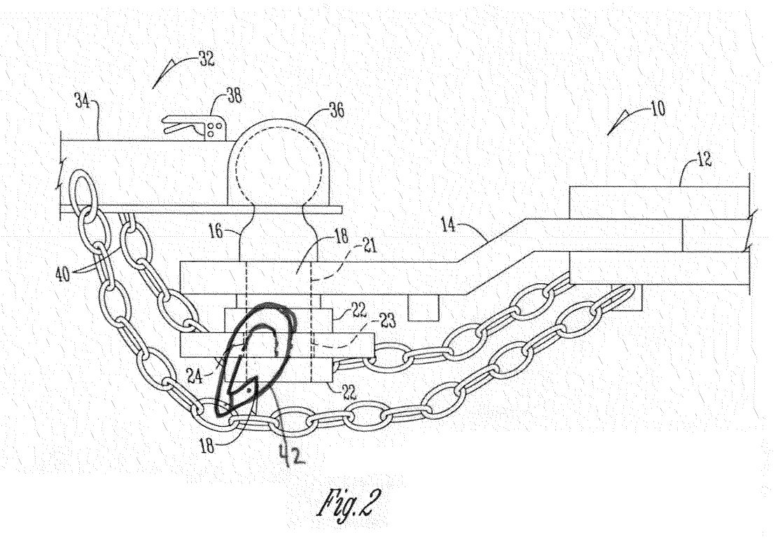

### DETAILED DESCRIPTION OF THE PREFERRED EMBODIMENT

Referring to the figures, a hitch assembly 10 includes a receiver 12 attached to a vehicle (not shown). Connected to and extending outwardly from the receiver 12 is an extension member 14. Connected to the extension member 14 is a hitch ball 16 having a shaft 18 and shoulder 20 which are held in place by nuts and washer 28. The shaft 18 extends through an aperture 21 in the end of the extending member 14.

Pivotally connected to the hitch assembly 10 is a swivel plate assembly 18. The swivel plated assembly 18 is of any size and shape and includes a swivel plate 20 having a central opening 23 and a pair of chain openings 24. In one embodiment the swivel plate 20 is connected to the extension member 14 below the ball 16 such that the shaft 18 of the ball 16 is received in central opening 23. The swivel member 20 is pivotally connected to a shaft 26 extending from the extension member 14 away from the ball 16 or to the receiver 12.

In one embodiment a pair of support members 28 extend upwardly from the swivel plate 20. A locking stop 30 is received through aligned openings 31 in each of the support members 28. Also a strength plate 33 is connected to the bottom of the swivel plate 20.

Connected to the ball 16 is a tongue 32. The tongue has an elongated member 34 with a spherical socket 36 for receiving the ball 16 and a locking clamp 38. Connected to the elongated member 34 are a pair of chains 40. The chains are connected to the swivel plate 20 by hooks 42 that are received in openings 24. The hooks 42 are either connected to an end of the chains 40 or between the ends when one end is connected to the receiver 12.

In operation, when the ball 16 is sheared or the locking clamp 38 malfunctions, the tongue 32 is disconnected from the hitch assembly 10. When this occurs, rather than falling to the ground the chains 40 support the tongue 32 between the elongated member 34 and the swivel plate 20. The pivoting motion and the support of the chains 40 maintain a center point pull reducing accidents.

The locking stop 30 is positioned to prevent the spherical socket 36 from rising off of the ball 16 and provides a further means of maintaining a center point pull.

Accordingly, a swivel plate assembly for a hitch has been disclosed that at the very least meets all of the sated objectives.

1. A swivel plate assembly for a vehicle hitch comprising:
a swivel plate pivotally connected to a hitch assembly;
a tongue connected to the hitch assembly by a pair of chains; and
a pair of hooks connecting the pair of chains to the swivel plate.

2. The assembly of claim 1 wherein the swivel plate has a pair of chain openings.

3. The assembly of claim 1 wherein the swivel plate has a pair of support members that extend upwardly from the swivel plated and received a locking stop through aligned openings.

4. The assembly of claim 1 wherein the hooks are connected to an end of the pair of chains.

5. The assembly of claim 1 wherein the hooks are connected between the ends of the pair of chains.

6. The assembly of claim 1 further comprising a strength plate connected to the bottom of the swivel plate.

7. The assembly of claim 1 wherein when the tongue is disconnected from the hitch assembly the pair of chains support the tongue.

8. The assembly of claim 1 wherein when the tongue is disconnected from the hitch assembly the swivel plate maintains a center point pull.
